(19) United States
(12) Patent Application Publication
(10) Pub. No.: US 2019/0102784 A1
(43) Pub. Date: Apr. 4, 2019

(54) MODELING SEQUENTIAL ACTIONS

(71) Applicant: Facebook, Inc., Menlo Park, CA (US)

(72) Inventors: Zheng Chen, Mountain View, CA (US); Robert Oliver Burns Zeldin, Los Altos, CA (US); Shyamsundar Rajaram, San Francisco, CA (US); Hao Song, Sunnyvale, CA (US); Nimish Rameshbhai Shah, Cupertino, CA (US)

(21) Appl. No.: 15/722,126

(22) Filed: Oct. 2, 2017

(51) Int. Cl. G06Q 30/02

(52) U.S. Cl. CPC G06Q 30/0202; G06Q 30/0275; G06Q 30/0277; G06Q 30/0255

(57) ABSTRACT

A bidding system determines values for impression opportunities on an online system. Values are determined by a set of models. Each model of the set of models is associated with a user response and predicts the likelihood that the associated user response will occur following an impression. The models are ordered based on a predicted chronological ordering of user actions that lead towards a conversion. Each model is weighted based on its relevance to conversion and the accuracy of the model relative to the other models in the set of models. Predictions of the probability of user action generated by each model, as well as the model weights, are used to determine a value for impression opportunities. Data from impression opportunities are then used to further train the models and update the weights assigned to each model for use in determining values for subsequent impression opportunities.

### BACKGROUND

This disclosure relates generally to a computer modeling user actions, and particularly to modeling sequential actions.

Impression opportunities arise when a content slot located on an online system is identified as available for content presentation to a user viewing the online system. In response to the arrival of an impression opportunity, one or more content campaigns may bid on the opportunity. The campaign with the highest bid wins the impression opportunity, and the campaign subsequently presents a content item to the user associated with the impression opportunity. In determining a bid amount for the impression opportunity, campaigns may predict the value to be gained from the impression opportunity.

Value is gained from an impression opportunity when the user that receives the impression performs one or more actions that fulfill one or more objectives associated with the campaign. To predict the fulfillment of campaign objectives by a user, the user's actions following viewing of the content can be modeled and predicted. Some existing action prediction systems rely only upon data gathered from a small subset of users that received the impression. For example, for a campaign that specifies that its ultimate objective is purchase of a product, a value prediction system may predict user fulfillment of campaign objectives based only on data gathered from users that affirmatively chose to purchase a product after receiving the impression. These systems do not take advantage of the chain of decisions and actions that ultimately lead up to a final decision to purchase, or refrain from purchasing, a product. Additionally, because only a small proportion of users presented with a content item purchase the associated product, these systems only have a small sample size of data available for use in predicting. This unideal situation in turn results in prediction of inaccurate values for impressions based on limited data. Additionally, because only a small portion of users presented with a content item actually convert, a long time is required to accrue enough data to accurately predict user behavior in converting.

### SUMMARY

An online system identifies an impression opportunity to present a content item associated with a content campaign to a user. An impression opportunity arises when a content slot located on the online system is identified as available for content presentation to a user viewing the online system. In one embodiment, the user may be deemed eligible for viewing the content item based on targeting criteria specified by the online system and fulfilled by the user.

The online system then determines a value for a content campaign for the impression opportunity to present content of the content campaign. The value may be based on an expected value, such as monetary compensation, provided by the third party system to the online system if the content item is presented to the user, if the content item receives interaction from the user when presented, or if any suitable condition is satisfied when the content item is presented to a user. For example, the expected value specifies a monetary amount that the online system receives from the third party system if content in the content item is displayed.

The value of the content campaign is determined by a set of models associated with the content campaign, wherein each model of the set of models is associated with a weight. Specifically, the weighted set of models determines the value for the impression opportunity in the following manner.

First, user characteristics of the user involved in the impression opportunity are applied to a set of models associated with the content campaign to predict a set of user actions after viewing the content item, each model predicting a likelihood of the user performing a respective user action in the set of user actions. Examples of user characteristics include biographic, demographic, and other types of descriptive information, such as work experience, educational history, gender, hobbies or preferences, location and the like. The set of models comprises one or more individual models. Each individual model is associated with a user action, and each individual model is trained to predict the likelihood that the user action associated with the given model will occur. For example, a model that is associated with an objective of a user adding a product to a shopping cart is trained to predict the probability that a given user will add a given product to their shopping cart. In some embodiments, the user actions associated with individual models are objectives of the content campaign as specified by the third party system or the online system itself.

The one or more individual models that comprise the set of models are ordered within the set based on a predicted chronological ordering of user actions associated with each model. In other words, the models are ordered such that each subsequent user action is most likely to be performed immediately following the prior action. For example, an add to cart action is likely to be performed just prior to a purchase action. Thus a model associated with the add to cart action would be placed just ahead of a model associated with the purchase action within the set of models. The final model of the set of models is associated with the true objective of the content campaign. Thus all models prior to the final model are associated with user actions leading up to the true objective of the content campaign.

As previously mentioned, each model within the set of models predicts the probability that the user action associated with the given model will occur. This prediction is used to determine a value for the impression opportunity. In other words, each model within the set of models outputs a value for the impression opportunity that has been determined by the model to be of the highest value with regard to fulfilling the user action associated with that model. To reach one final value for the impression opportunity, each model within the set of models is also assigned a weight to combine the respective values of the models.

Assigning a weight to each model of the set of models enables more relevant, better trained models to have a greater input in the final value calculated, making calculation of the highest value possible. Model weights may be assigned based on a variety of factors. In some embodiments, a model's weight may be designated based on a sample size or a quantity of data that has been used to train the model. In alternative embodiments, a models weight may be designated based on the success that the model has in accurately predicting the occurrence of user fulfillment of the objective associated with the model. In further embodiments, the model's weight may be designated by the similarity of the objective associated with the model to the ultimate objective of the content campaign.

Finally, a final value for the impression opportunity is determined by applying the weighting assigned to each model to the value calculated by that model. The final value is determined and used by the online system to evaluate whether or not to present the content item to the user.

Once the value has been received by the online system, the online system determines whether the campaign has the highest value compared to other content items to be placed in the impression opportunity. If the value for the campaign is greater than other values for other content items, the content item for the campaign “wins” the impression opportunity, and the content item associated with the third party system is presented to the user associated with the impression opportunity.

Next, the online system identifies one or more responses of the user to the presented content item. User responses may be negative or positive responses. For example, one user might not click on the presented content item, while a second user does click on the presented content item. Both the lack of action of not clicking, and the affirmative clicking action are considered user responses.

The set of models are then updated with data describing the impression opportunity and the one or more responses of the user to the presented content item. In other words, the models of the set of models are trained using data from the impression opportunity such that they are better able to determine a value for a subsequent impression opportunity.

Finally, the weight associated with each model of the set of models is updated. As described above, the weights assigned to each model are based on a variety of factors and enable more relevant, better trained models to have a greater input in the final value calculated, making calculation of the highest value possible for the next impression opportunity. As one example, as additional information and confidence about the individual actions' modeling improves, the weighing of the models predicting ‘later’ user actions increases. This approach also permits effective initial modeling before significant information is available for later user actions by modeling the earlier user actions and weighing these models when they are the more reliable predictor of downstream actions.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a block diagram of a funnel optimization module, in accordance with an embodiment.

FIG. 4 is a collection of data associated with presentation of a content item to users of an online system, in accordance with an embodiment.

FIG. 5 illustrates responses of users of an online system to a content item, in accordance with an embodiment.

FIG. 6 illustrates responses of users of an online system to a content item received by models within a model funnel, in accordance with one embodiment.

FIG. 7 illustrates a progression of model usage over time, in accordance with one embodiment.

FIG. 8 is a flow chart of a method for determining a value for an impression opportunity, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

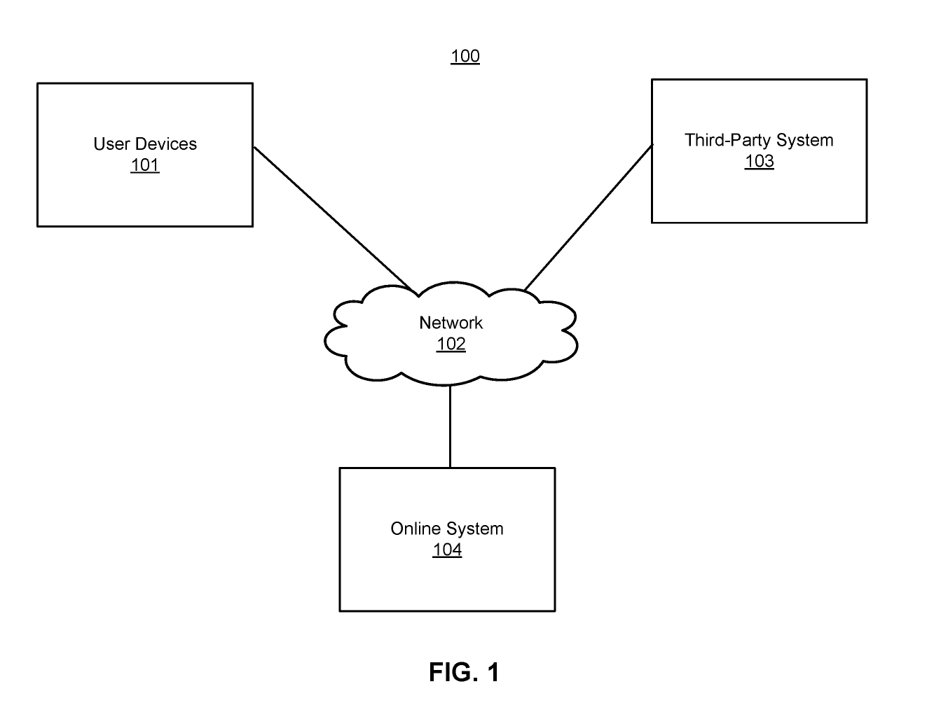

FIG. 1 is a block diagram of a system environment 100 for an online system 104. The system environment 100 shown by FIG. 1 comprises one or more user devices 101, a network 102, one or more third-party systems 103, and the online system 104. In alternative configurations, different and/or additional components may be included in the system environment 100. For example, the online system 104 is a social networking system, a content sharing network, or another system providing content to users.

The user devices 101 are one or more computing devices capable of receiving user input as well as transmitting and/or receiving data via the network 102. In one embodiment, a user device 101 is a conventional computer system, such as a desktop or a laptop computer. Alternatively, a user device 101 may be a device having computer functionality, such as a personal digital assistant (PDA), a mobile telephone, a smartphone, or another suitable device. A user device 101 is configured to communicate via the network 102. In one embodiment, a user device 101 executes an application allowing a user of the user device 101 to interact with the online system 104. For example, a user device 101 executes a browser application to enable interaction between the user device 101 and the online system 104 via the network 102. In another embodiment, a user device 101 interacts with the online system 104 through an application programming interface (API) running on a native operating system of the user device 101, such as IOS® or ANDROID™.

The user devices 101 are configured to communicate via the network 102, which may comprise any combination of local area and/or wide area networks, using both wired and/or wireless communication systems. In one embodiment, the network 102 uses standard communications technologies and/or protocols. For example, the network 102 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 102 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 102 may be represented using any suitable format, such as hypertext markup language (HTML) or extensible markup language (XML). In some embodiments, all or some of the communication links of the network 102 may be encrypted using any suitable technique or techniques.

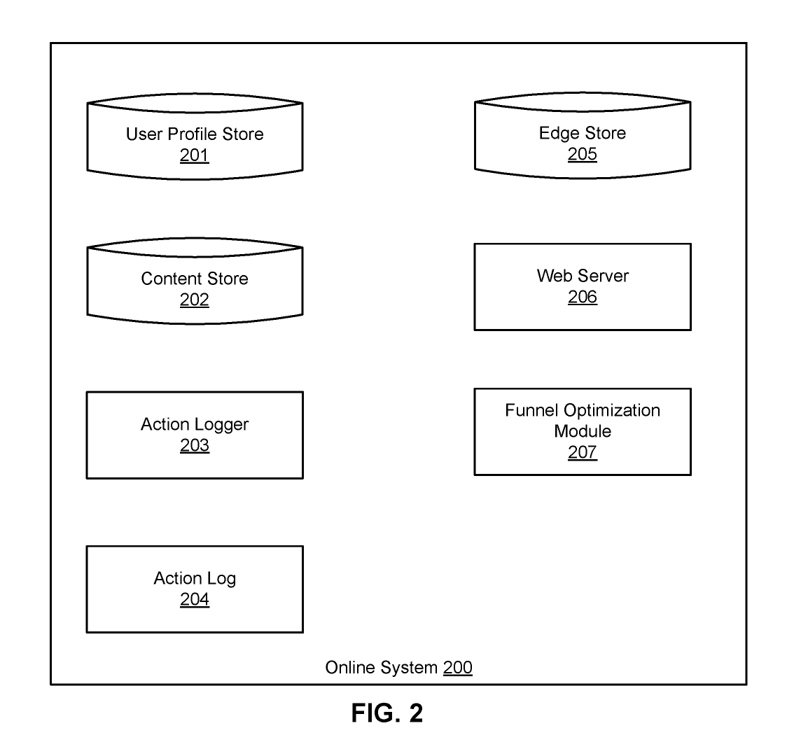

One or more third party systems 103 may be coupled to the network 102 for communicating with the online system 104, which is further described below in conjunction with FIG. 2. In one embodiment, a third party system 103 is an application provider communicating information describing applications for execution by a user device 101 or communicating data to user devices 101 for use by an application executing on the user device. In other embodiments, a third party system 103 provides content or other information for presentation via a user device 101. A third party system 103 may also communicate information to the online system 104, such as advertisements, content, or information about an application provided by the third party system 103.

FIG. 2 is an embodiment 200 of an architecture of the online system 104. The online system 200 shown in FIG. 2 includes a user profile store 201, a content store 202, an action logger 203, an action log 204, an edge store 205, a web server 206, and a funnel optimization module 207. In other embodiments, the online system 200 may include additional, fewer, or different components for various applications. Conventional components such as network interfaces, security functions, load balancers, failover servers, management and network operations consoles, and the like are not shown so as to not obscure the details of the system architecture.

Each user of the online system 200 is associated with a user profile, which is stored in the user profile store 201. A user profile includes declarative information about the user that was explicitly shared by the user and may also include profile information inferred by the online system 200. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 201 may also maintain references to actions by the corresponding user performed on content items in the content store 202 and stored in the action log 204.

While user profiles in the user profile store 201 are frequently associated with individuals, allowing individuals to interact with each other via the online system 200, user profiles may also be stored for entities such as businesses or organizations. This allows an entity to establish a presence on the online system 200 for connecting and exchanging content with other online system users. The entity may post information about itself, about its products or provide other information to users of the online system 200 using a brand page associated with the entity's user profile. Other users of the online system 200 may connect to the brand page to receive information posted to the brand page or to receive information from the brand page. A user profile associated with the brand page may include information about the entity itself, providing users with background or informational data about the entity.

The content store 202 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 202, such as status updates, photos tagged by users to be associated with other objects in the online system 200, events, groups or applications. In some embodiments, objects are received from third-party applications or third-party applications separate from the online system 200. For example, a third-party may contribute one or more advertisements to the content store 202. In one embodiment, objects in the content store 202 represent single pieces of content, or content “items.” Hence, online system users are encouraged to communicate with each other by posting text and content items of various types of media to the online system 200 through various communication channels. This increases the amount of interaction of users with each other and increases the frequency with which users interact within the online system 200.

One or more content items included in the content store 202 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item and is used to determine an expected value, such as monetary compensation, provided by a content sponsor to the online system 200 if content in the content item is presented to a user, if the content in the content item receives a user interaction when presented, or if any suitable condition is satisfied when content in the content item is presented to a user. For example, the expected value specifies a monetary amount that the online system 200 receives from a content sponsor who provided the content item to the online system 200 if content in the content item is displayed. In some embodiments, the expected value to the online system 200 of presenting the content from the content item may be determined by multiplying the bid amount by a probability of the content of the content item being accessed by a user. In alternative embodiments, an expected value is specified by the third party system associated with the campaign for each model within the set of models. In other words, the third party system may specify an expected, monetary value for each action included in the set of models. For example, the third party system may specify that a purchase action is worth an expected value of $10 and an add to cart action is worth an expected value of $3. In alternative embodiments, the third party system may only specify an expected value for the ultimate campaign objective. For example, if the ultimate campaign objective is purchase of a product, the third party system may only specify an expected value for product purchase. In such embodiments, the online system may impute the expected value for actions included in the set of models that may be performed prior to the final action of product purchase. Computation of an expected value for an action preceding the final action may be based on a probability that the final action occurs given occurrence of the action preceding the final action, as well as the occurrence of any additional actions that precede the final action. For example, assume that a third party system specifies that their final campaign objective is a purchase action. Furthermore, assume that the third party system specifies that the purchase action is worth an expected value of $10. However, assume that the third party system does not specify expected values for actions prior to this final purchase action. In this case, the online system may assign the add to cart action a $3 expected value if it has been determined that 30% of add to cart actions result in the user purchasing the product.

In various embodiments, a content item includes various components capable of being identified and retrieved by the online system 200. Example components of a content item include: a title, text data, image data, audio data, video data, a landing page, a user associated with the content item, or any other suitable information. The online system 200 may retrieve one or more specific components of a content item for presentation in some embodiments. For example, the online system 200 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 200 logs interactions between users presented with the content item or with objects associated with the content item. Additionally, the online system 200 receives compensation from a content sponsor associated with the content item as online system users perform interactions with a content item that satisfy the objective included in the content item.

Additionally, a content item may include one or more targeting criteria specified by the content sponsor who provided the content item to the online system 200. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 200. Targeting criteria may also specify interactions between a user and objects performed external to the online system 200, such as on a third party system 103. For example, targeting criteria identifies users that have taken a particular action, such as sent a message to another user, used an application, joined a group, left a group, joined an event, generated an event description, purchased or reviewed a product or service using an online marketplace, requested information from a third party system 103, installed an application, or performed any other suitable action. Including actions in targeting criteria allows users to further refine users eligible to be presented with content items. As another example, targeting criteria identifies users having a connection to another user or object or having a particular type of connection to another user or object.

In various embodiments, the content store 202 includes multiple content campaigns, which each include one or more content items. In various embodiments, a content campaign is associated with one or more characteristics that are attributed to each content item of the content campaign. For example, a bid amount associated with a content campaign is associated with each content item of the campaign. Similarly, an objective associated with a content campaign is associated with each content item of the content campaign. In various embodiments, a content sponsor providing content items to the online system 200 provides the online system 200 with various content campaigns each including content items having different characteristics (e.g., associated with different content, including different types of content for presentation), and the content campaigns are stored in the content store.

The action logger 203 receives communications about user actions internal to and/or external to the online system 200, populating the action log 204 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 204.

The action log 204 may be used by the online system 200 to track user actions on the online system 200, as well as actions on third party systems 103 that communicate information to the online system 200. Users may interact with various objects on the online system 200, and information describing these interactions is stored in the action log 204. Examples of interactions with objects include: commenting on posts, sharing links, checking-in to physical locations via a user device 101, accessing content items, and any other suitable interactions. Additional examples of interactions with objects on the online system 200 that are included in the action log 204 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 204 may record a user's interactions with sponsored content on the online system 200 as well as with other applications operating on the online system 200. In some embodiments, data from the action log 204 is used to infer interests or preferences of a user, augmenting the interests included in the user's user profile and allowing a more complete understanding of user preferences.

The action log 204 may also store user actions taken on a third party system 103, such as an external website, and communicated to the online system 200. For example, an e-commerce website may recognize a user of an online system 200 through a social plug-in enabling the e-commerce website to identify the user of the online system 200. Because users of the online system 200 are uniquely identifiable, e-commerce websites, such as in the preceding example, may communicate information about a user's actions outside of the online system 200 to the online system 200 for association with the user. Hence, the action log 204 may record information about actions users perform on a third party system 103, including webpage viewing histories, sponsored content that were engaged, purchases made, and other patterns from shopping and buying. Additionally, actions a user performs via an application associated with a third party system 103 and executing on a user device 101 may be communicated to the action logger 203 by the application for recordation and association with the user in the action log 204.

In one embodiment, the online system 200 uses a tracking pixel or piece of HTML code placed on third-party websites 103 to monitor users visiting the websites that have not opted out of tracking. A tracking pixel might be included on various pages, including on a product page describing a product, on a shopping cart page that the user visits upon putting something into a shopping cart, on a checkout page that the user visits to checkout and purchase a product, etc. For example, a tracking pixel results in a transparent 1×1 image, an iframe, or other suitable object being created for third party pages. When a user's browser loads a page having the tracking pixel, the tracking pixel results in the user's browser attempting to retrieve the content for that pixel, and the browser contacts the online system 200 to retrieve the content. The request sent to the online system 200, however, actually includes various data about the user's actions taken on the third party website 103. The third party website 103 can control what data is sent to the online system 200. For example, the third party system 103 may include information about the page the user is loading (e.g., is it a product page, a shopping cart page, a checkout page, etc.), about information on the page or about a product on the page of interest to the user (e.g., the SKU number of the product, the color, the size, the style, the current price, any discounts offered, the number of products requested, etc.), about the user (e.g., the third party's user identifier (UID) for the user, contact information for the user, etc.), and other data. In some embodiments, a cookie set by the online system 200 can also be retrieved by the online system 200, which can include various data about the user, such as the online systems' UID for the user, information about the user device and the browser, such as the Internet Protocol (IP) address of the user device, among other data. Tracking can also be performed on mobile applications of content providers by using a software development kit (SDK) of the online system 200 or via an application programming interface (API) of the online system 200 to track events (e.g., purchases) that occur by users on the content provider's app that are reported to the online system 200.

The online system 200 can then use this data received about the user to serve better content to the user in the future (e.g., since the online system 200 has further data about products purchased or browsed that might be of interest), and can also use this in retargeting of that product to the user (e.g., where the user went to the product page on the third party site 103 by clicking on an of the third party 103 presented to the user in the online system 200). The online system 200 can also use this data in conversion tracking and reporting results of advertising campaigns to the third party 103. For example, if the third party 103 has spent money at the online system 200 to have the online system 200 serve ads for its products, and a particular user views an ad on the online system 200 and then purchases the product sponsored (possibly at some point later, and possibly on a different device), the online system 200 can link the purchase/conversion to the ad originally shown on the online system 200. Thus, the online system 200 can include this data in its reporting to the third party system 103 of how many conversions the ad campaign received.

In one embodiment, the edge store 205 stores information describing connections between users and other objects on the online system 200 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 200, such as expressing interest in a page on the online system 200, sharing a link with other users of the online system 200, and commenting on posts made by other users of the online system 200.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 200, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 205 also stores information about edges, such as affinity scores for objects, interests, and other users. Affinity scores, or “affinities,” may be computed by the online system 200 over time to approximate a user's interest in an object or in another user in the online system 200 based on the actions performed by the user. A user's affinity may be computed by the online system 200 over time to approximate the user's interest in an object, in a topic, or in another user in the online system 200 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 205, in one embodiment. Alternatively, each interaction between a user and a specific object is stored as a separate edge. In some embodiments, connections between users may be stored in the user profile store 201, or the user profile store 201 may access the edge store 205 to determine connections between users.

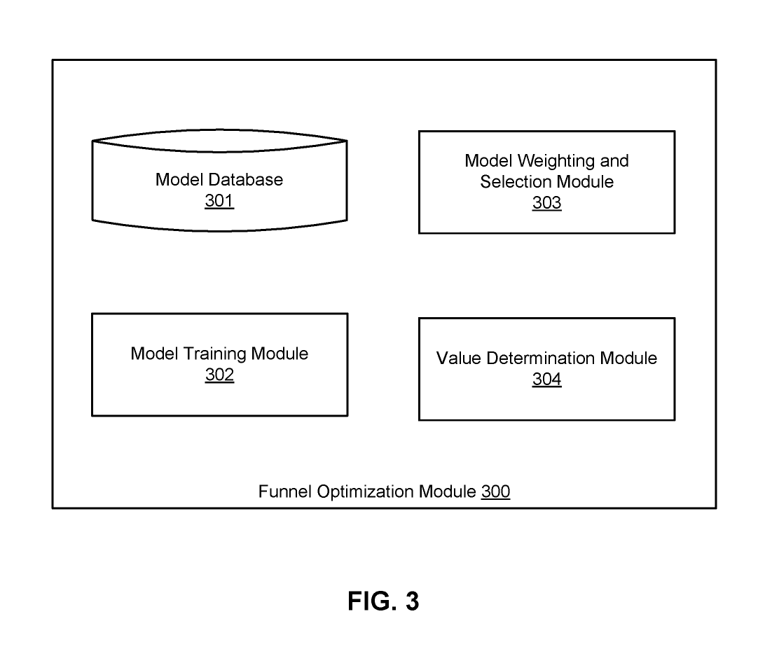

In some embodiments, information describing users of the online system 200 sourced from the user profile store 201, the action log 204, and the edge store 205 may be used by the funnel optimization module 207. Such embodiments are described in greater detail with regard to FIG. 3.

The web server 206 links the online system 200 via the network 102 to the one or more user devices 101, as well as to the one or more third party systems 103. The web server 206 serves web pages, as well as other content, such as JAVA®, FLASH®, XML and so forth. The web server 206 may receive and route messages between the online system 200 and the user device 101, for example, instant messages, queued messages (e.g., email), text messages, short message service (SMS) messages, or messages sent using any other suitable messaging technique. A user may send a request to the web server 206 to upload information (e.g., images or videos) that are stored in the content store 202. Additionally, the web server 206 may provide application programming interface (API) functionality to send data directly to native user device operating systems, such as IOS®, ANDROID™, or BlackberryOS.

The funnel optimization module 207 uses a set of one or more ordered models, hereafter referred to as a “model funnel,” to determine values for a content campaign initiated by a third party 103. The operation of the funnel optimization module 207 is described in further detail with regard to FIG. 3 below.

### DETAILED DESCRIPTION

FIG. 3 is an embodiment 300 of the funnel optimization module 207. The funnel optimization module 300 shown in FIG. 3 includes a model database 301, a model training module 302, a model weighting and selection module 303, and a value determination module 304. In other embodiments, the funnel optimization module 300 may include additional, fewer, or different components for various applications.

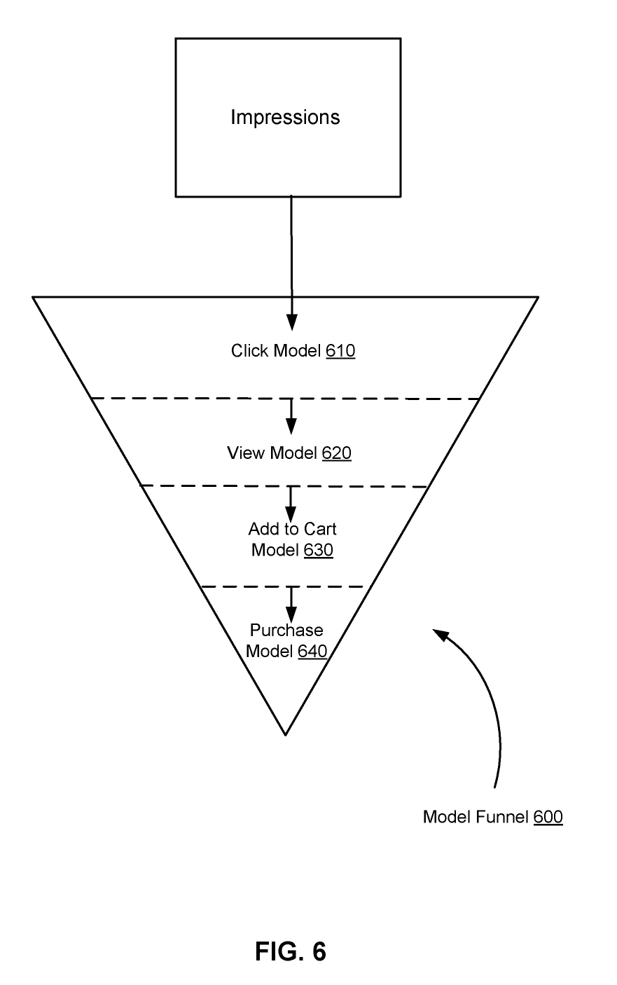

The model database 301 stores models that are trained to determine values for a content campaign based on automated prediction of user actions with respect to objectives of the content campaign. As mentioned above with regard to FIG. 2, the models stored in the model database 301 are organized into ordered sets of models called model funnels. In some embodiments, each model funnel within the model database 301 is associated with a unique content campaign. As an example, a particular model funnel within the model database 301 may be trained to determine a value for a running shoe campaign sponsored by a shoe store while a different module funnel within the model database 301 may be trained to determine a value for a wild salmon campaign sponsored by a grocery store. Each model within a model funnel is further associated with a particular action in a set of actions related to an objective of a campaign. Model funnels and their constituent models will be described in further detail with regard to FIG. 6.

The model training module 302 applies machine learning techniques to train models of a model funnel to determine values of a content campaign. To train the models, the model training module 302 uses data from impression events. An impression event is presentation of a content item associated with a content campaign to a user. Data from impression events may include information about the user to which the content is presented, information about the content itself, information about the setting in which the content is presented to the user, and information about the user's response to the content. Additional embodiments of data that may be used by the model training module 302 may not be explicitly included here. An ordered list of the data associated with an impression event is herein referred to as the feature vector for the impression event. In one embodiment, the model training module 302 applies dimensionality reduction (e.g., via linear discriminant analysis (LDA), principle component analysis (PCA), or the like) to reduce the amount of data in the feature vectors for impression events to a smaller, more representative set of data.

The model training module 302 uses supervised machine learning to train the models, with the feature vectors for impression events serving as the inputs. Different machine learning techniques—such as linear support vector machine (linear SVM), boosting for other algorithms (e.g., AdaBoost), neural networks, logistic regression, naive Bayes, memory-based learning, random forests, bagged trees, decision trees, boosted trees, or boosted stumps—may be used in different embodiments. The models, when applied to a feature vector extracted from an impression opportunity, output an updated value for subsequent impression opportunities.

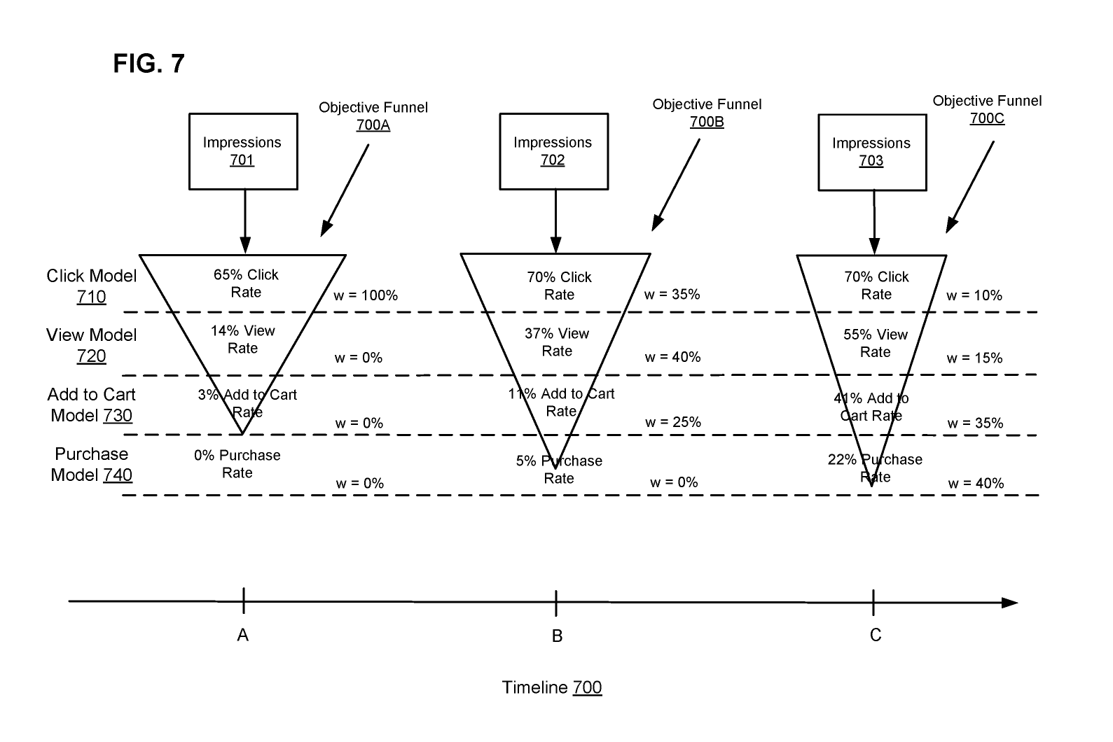

In some embodiments, a validation set is formed of additional impression events, other than those in the training sets. The model training module 302 applies the trained models to the impression events of the validation set to quantify the accuracy of the models. Common metrics applied in accuracy measurement include: Precision=TP/(TP+FP) and Recall=TP/(TP+FN), where precision is how many the models correctly predicted (TP or true positives) out of the total it predicted (TP+FP or false positives), and recall is how many the models correctly predicted (TP) out of the total number of impression events whose outcomes did fulfill or exceed the determined value (TP+FN or false negatives). The F score (F-score=2*PR/(P+R)) unifies precision and recall into a single measure. In one embodiment, the model training module 302 iteratively re-trains the models until the occurrence of a stopping condition, such as the accuracy measurement indication that the model is sufficiently accurate, or a number of training rounds having taken place. Models within the model database 301 are continuously updated as the models are trained by the model training module 302. The training and validation of models within model funnels will be described in further detail with regard to FIG. 7.

The model weighting and selection module 303 determines which models within a model funnel to use in determining a value for a content campaign. In some embodiments, the model weighting and selection module 303 selects a single model for determining a value for the campaign based on the model's prediction of a user's likelihood to perform the action associated with the single model. In other embodiments, the model weighting and selection module 303 determines how to weight the value determined by each model. For example, a determined value from a model A might be weighted by 20% while an alternative value determined by a model B might be weighted by 80%. The selection and weighting of models within a model funnel is based on a confidence in each of the models, and on the campaign objectives associated with each model. The selection and weighting of models is described in further detail with regard to FIG. 7.

The value determination module 304 outputs a final value for a content campaign. The final value is based on outputs from a model funnel associated with the campaign, the outputs from the model funnel having been modified according to outputs from the model weighting and selection module 303 as described above. This final value is used to determine whether to present the content item associated with the campaign to the user.

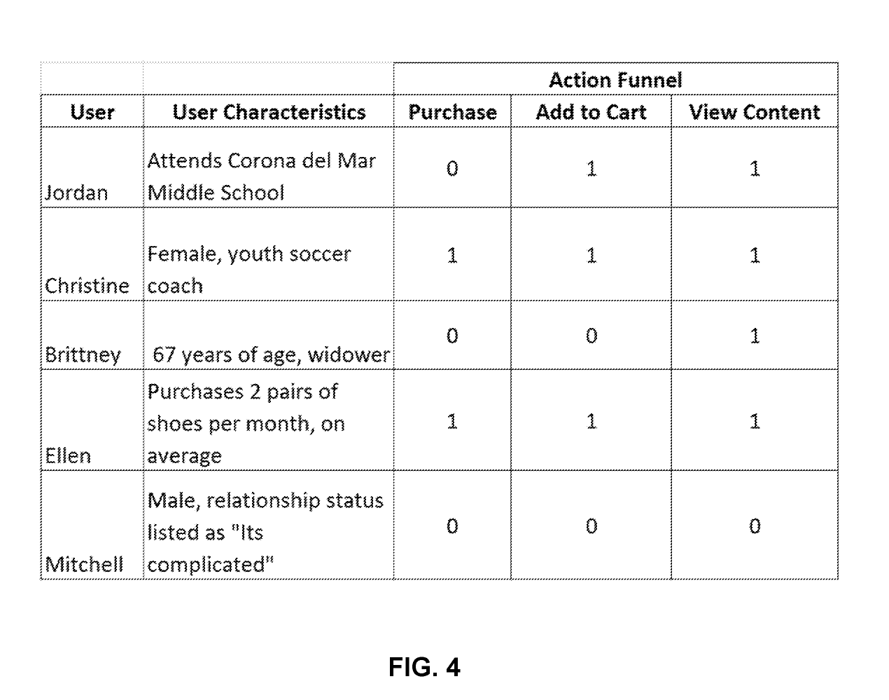

FIG. 4 depicts a collection of data associated with the presentation of content from a content campaign to online system users. Specifically, for each user presented with content from the content campaign, FIG. 4 depicts the user's name, characteristics, and responses to the content. In some embodiments, data similar to the data depicted in FIG. 4 may be used to train models of a model funnel associated with the content campaign. The model funnel may then be used to determine future values for the content campaign.

Responses to content presented to a user include the decision to view or ignore the content, the decision to add or refrain from adding a product sponsored by the content to an online shopping cart, and the decision to purchase or refrain from purchasing the product. While each of these three responses is a separate, distinct event, the three responses are collectively referred to as an “action funnel.” The action funnel depicts the outcomes of various campaign objectives that are expected to happen in sequence before a user's ultimate decision to perform an ultimately-desired action for the content campaign. Note that a value of ‘0’ indicates that the user did not perform the corresponding action, while a value of ‘1’ indicates that the user did perform the corresponding action.

The objectives that comprise an action funnel are ordered sequentially such that each subsequent objective is most likely to be performed following the prior objective. For example, as depicted in FIG. 4, the add to cart objective is likely to be performed prior to the purchase objective. Thus the add to cart objective is placed before the purchase objective within the action funnel. In most cases, the final objective of the action funnel is the true objective of the content sponsor. And often, the true objective of a content sponsor is purchase of the product sponsored. In such cases, objectives within the action funnel that lie ahead of the purchase objective would be steps leading up to the possible purchase. For example, as mentioned above, an objective that might be fulfilled just prior to purchase of a product is adding the product to a shopping cart. And an objective that might be fulfilled just prior to adding a product to a shopping cart is viewing a content item associated with the product. There are many embodiments of selections and arrangements of objectives that comprise an action funnel. Selection and arrangement of these objectives is described in greater detail with regard to subsequent figures.

As noted above, in many cases, the ultimate objective of a content campaign is for online system users targeted by the content campaign to purchase the product sponsored by the campaign. For example, as indicated by the number ‘1’ below the ‘purchase’ label of the action funnel, both Christine and Ellen purchased the sponsored product. Based on this objective achievement, it can be determined that Christine and Ellen were valuable sponsored content recipients, and data generated through the impression events associated with Christine and Ellen can be used to train models of the model funnel associated with the content campaign to efficiently target future sponsored content candidates.

However, more often than not, this ultimate purchase objective is not fulfilled. In other words, oftentimes sponsored content recipients do not ultimately decide to purchase the product. In these cases, if purchase data was the only data gathered for each impression event, it may be concluded that all sponsored content recipients that refrained from purchasing the product are equally not valuable. For example, if only purchase data was collected, Jordan, Brittney, and Mitchell (who all refrained from purchasing the product as indicated by the number ‘0’ below the ‘purchase’ label) would all be deemed as equally worthless sponsored content recipients.

While the decision to purchase or refrain from purchasing a product is the final objective of many content campaigns, the decision to purchase or refrain from purchasing a product can be broken down into multiple decisions that culminate in the decision to purchase or refrain from doing so. These events foreshadowing a purchase event may be collected and used to more precisely appraise the value of sponsored content recipients and train models predicting purchase occurrence in circumstances in which little data concerning the purchase event itself is available. For example, as seen in FIG. 4, two events that precede the purchase event include the ‘view content’ event and the ‘add to cart’ event. Additional embodiments not explicitly included here may also be used.

As shown in FIG. 4, including additional data with from purchase data can greatly distinguish the value between sponsored content recipients. For example, while Jordan, Brittney, and Mitchell all did not purchase the product, each user engaged in a unique sequence of events that resulted in that decision to refrain from purchase. Specifically, while Jordan did not ultimately purchase the content, FIG. 4 shows that she both viewed the content and added the content to her shopping cart. Brittney did not purchase the product or add it to her shopping cart, but she did view the content. And finally, Mitchell did not purchase the content, add it to his shopping cart, or even view the content. This differentiation between user interactions with the product, despite the ultimate uniformity in purchase decision, illuminates an opportunity distinguish between the values associated with each sponsored content recipient. Even though none of the users engaged in the ultimately desired objective of purchasing the product, Jordan proved to be a more valuable sponsored content recipient than Brittney because Jordan added the content to her shopping cart, indicating that she almost chose to purchase the product, while Brittney only viewed the content associated with the product. Furthermore, Brittney proved to be a more valuable sponsored content recipient than Mitchell because Brittney viewed the content associated with the product, demonstrating an interest in the product, while Mitchell did not even view the content associated with the product. By collecting data describing events leading up to the purchase event, additional data becomes available for use in assigning value to sponsored content recipients and predicting impression opportunity outcomes. The use of an increased volume of data results in more precise assignment of value to sponsored content recipients and more precise modeling of impression opportunity outcomes. This additional data and added precision of values can be used to justify presentation of an impression to Jordan before Brittney, as well as presentation of an impression to Brittney before Mitchell.

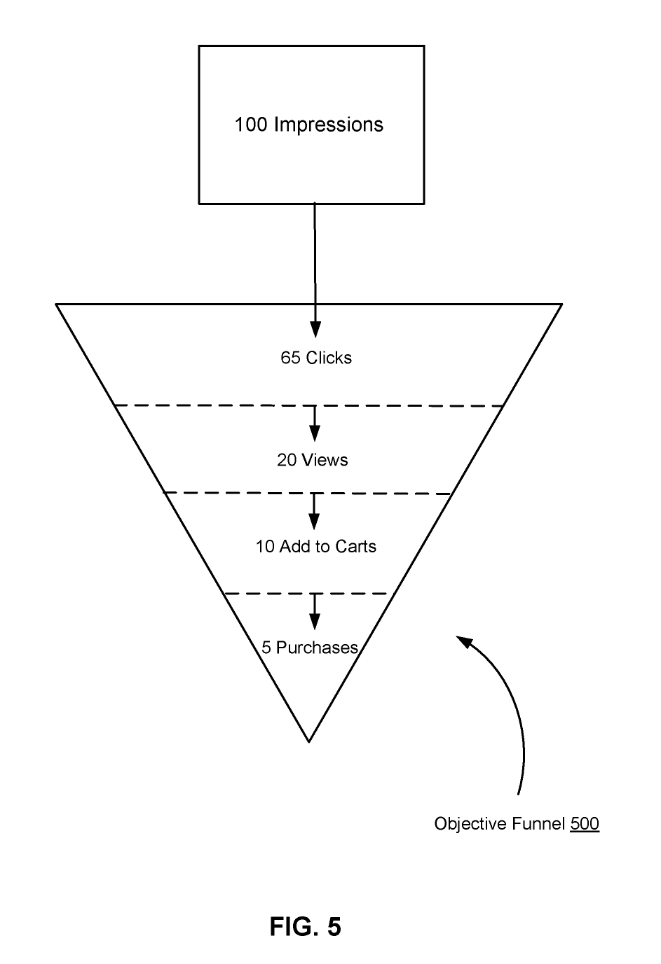

FIG. 5 illustrates a progression of user responses to content associated with a content campaign along an objective funnel 500. Specifically, content associated with a content campaign is presented to 100 unique users of the online system. In other words, 100 impression events occur. Each user responds to the content with a unique sequence of responses. An aggregated summary of these response sequences is illustrated within the objective funnel 500.

The objective funnel 500 depicts one embodiment of a progression of user interaction with the content. The objective funnel 500 includes multiple tiers of interaction objectives. Similarly to the action funnel described in FIG. 4, the objectives that comprise the objective funnel 500 are ordered sequentially such that each subsequent objective is most likely to be performed immediately following the prior objective. For example, as depicted in FIG. 5, click objective is likely to be performed just prior to the view objective. Thus the click objective is placed just ahead of the view objective within the objective funnel 500. Each subsequent tier of the objective funnel 500 brings the user closer to an ultimate objective, which is associated with the final tier of the objective funnel 500. In the embodiment provided in FIG. 5, the final tier of the objective funnel 500 is purchase. Thus purchase can be inferred to be the ultimate objective.

The tiers of the objective funnel 500 may be specified by the online system or by a third party associated with the content campaign. The objectives and ordering of the tiers associated with the objectives in objective funnel 500 is only one embodiment of an objective funnel. In alternative embodiments, any objectives in any combination may be used.

In the embodiment depicted in FIG. 5, the first tier of the objective funnel 500 corresponds to a “click” objective. The click objective is fulfilled when a user presented with the content clicks on the content to bring it into fuller view. The second tier of the objective funnel 500 corresponds to a “view” objective. The view objective is fulfilled when a user views the content for a specified period of time after clicking on the content. The third tier of the objective funnel 500 corresponds to an “add to cart” objective. The add to cart objective is fulfilled when a user adds the product associated with the content to a shopping cart, indicating an intent to purchase the product. The fourth and final tier of the objective funnel 500 corresponds to a “purchase” objective. The purchase objective is fulfilled when a user purchases the product associated with the content. As noted above, because the purchase objective is associated with the final tier of the objective funnel 500, it can be inferred that purchase of the product is the ultimate objective of the content campaign associated with the objective funnel 500.

The objective funnel 500 not only illustrates a progression of campaign objectives, but it also depicts an aggregated summary of the response sequences executed by the 100 users that were presented with the content. Of the 100 users that were presented with the content, 65 users clicked on the content. Of the 65 users that clicked on the content, 20 users viewed the content for a specified period of time. Of the 20 users that viewed the content, 10 users added the product associated with the content to a shopping cart. Finally, of the 10 users that added the product to a shopping cart, 5 users ultimately purchased the product. Because the number of users fulfilling the objective associated with each subsequent tier of the objective funnel 500 decreases, the funnel narrows with each subsequent tier and as a result takes the shape of an inverted triangle. Also, note that while a user is not required to progress linearly through each tier of the objective funnel 500, the ordering of the funnel's tiers approximates the natural progression of user interaction with the content, and thus in most cases user interactions do progress linearly down the funnel.

As described above, at each subsequent tier of the objective funnel 500, a smaller and smaller proportion of the initial set of users presented with the content engage in the specified objective. For example, only 5% of the users initially presented with the content ultimately purchase the product associated with the content. This presents a challenge for modeling purchase events because the sample size, and thus the data available to train the model, is so limited. Furthermore, because of the low conversion rate from content presentation to purchase of the product, accumulation of a large sample size and enough data to sufficiently train the purchase model would require a significant portion of time.

In order to circumvent this problem, while waiting for an accumulation of enough data to sufficiently train the purchase model, models of objectives associated with a larger sample size and a greater volume of data can be used to infer or predict purchase events, or other objectives associated with a smaller data set. In other words, models associated with a preceding tier of the objective funnel 500 that have an appropriate sample size, can be used to help predict the occurrence of subsequent objectives that are not yet associated with sample size sufficiently large enough to train the model associated with that objective. This revelation leads to the conception of the model funnel, described in greater detail below with regard to FIG. 6.

FIG. 6 illustrates a progression of data describing user responses to content associated with a content campaign along a model funnel 600. As discussed above with regard to FIG. 3, models within the model funnel 600 are trained to determine values for the content campaign. To do so, each model within the model funnel 600 is trained to predict occurrence of the objective associated with that model.

First, note that the model funnel 600 mirrors the objective funnel 500 of FIG. 5. Specifically, each tier of the model funnel 600 includes a model purposed to predict occurrence of the objective associated with the corresponding tier of the objective funnel 500. Thus the first tier of the model funnel 600 includes a click model 610 that predicts the occurrence of user clicks on the presented content, the second tier of the model funnel 600 includes a view model 620 that predicts the occurrence of user views of the presented content for a specified period of time, the third tier of the model funnel 600 includes an add to cart model 630 that predicts whether a user will add the product associated with the presented content to a shopping cart, and the fourth and final tier, representing the ultimate content campaign objective, includes a purchase model 640 that predicts whether a user will purchase the product. Model funnel 600 is only one embodiment of a model funnel. Alternative model funnels may include models predicting an alternative objective with any alternative ordering.

Returning to the problem of modeling the ultimate campaign objective using a small volume of data, recall that models predicting objectives associated with a larger sample size can be used to indirectly and more confidently predict occurrence of the ultimate objective. However, while use of the largest sample size and data set possible in training a model provides the most confidence in the precision and accuracy of the model, a balance between confidence in the model and similarity of the model to the ultimate objective must be maintained. For example, a model trained to predict clicks following presentation of content to a user would be relatively reliable because of the relatively large volume of data available to train the model. However, because purchase of the product is the ultimate objective of the content campaign, and user fulfillment of the click objective is only loosely related to user fulfillment of the purchase objective as seen by the distance between the two tiers in the objective funnel 500, in some cases, use of a model predicting clicks to aid in the prediction of purchases is irrelevant. Models predicting objectives that are more closely related to the ultimate purchase objective are more useful in predicting purchase events. For example, use of a model predicting the add to cart objective would be more efficient in aiding the predicting of purchases because the add to cart objective is more closely related to the purchase objective as seen in the objective funnel 500. However, recall that the sample size available to model a given objective must be great enough to produce sufficient confidence in the accuracy of the model. Achieving this balance between model confidence and similarity to the ultimate objective is discussed in greater detail below with regard to FIG. 7.

FIG. 7 illustrates a progression of model usage over time in determining a value for a content campaign. A timeline 700 illustrates the time over which the content campaign occurs. The timeline 700 designates three unique points in time during the content campaign: time A, time B, and time C. Time A is a time earlier than time B, and time B is a time earlier than time C. At each of the three times, a snapshot of the state of the objective funnel 500 from FIG. 5 is depicted. Time A is associated with an objective funnel 700A, time B is associated with an objective funnel 700B, and time C is associated with an objective funnel 700C. The objective funnel 700A, the objective funnel 700B, and the objective funnel 700C are depictions of the same funnel at different times, and thus in different states, throughout the content campaign.

As time passes, an increasing number of impressions occur. In other words, as time passes, more and more users of the online system are presented with the content associated with the content campaign. At time A, a quantity of impressions 701 have occurred. At time B, a quantity of impressions 702 have occurred. At time C, a quantity of impressions 703 have occurred. The quantity of impressions 701 is less than the quantity of impressions 702, which is in turn less than the quantity of impressions 703. Thus the greatest number of impressions have occurred at time C.

Note that each tier of the objective funnels 700A, 700B, and 700C is associated with a corresponding model. Because the objective funnels 700A, 700B, and 700C reflect the objective funnel 500, the models associated with each tier of the objective funnels 700A, 700B, and 700C reflect the model funnel 600 of FIG. 6. Thus the first tier of the objective funnels 700A, 700B, and 700C is associated with a click model 710, the second tier of the objective funnels 700A, 700B, and 700C is associated with a view model 720, the third tier of the objective funnels 700A, 700B, and 700C is associated with an add to cart model 730, and the fourth tier of the objective funnels 700A, 700B, and 700C is associated with a purchase model 740. As explained previously, each of these models predicts the occurrence of the objective associated with the tier at which the model resides. These predictions are used to determine a value that increases the overall value of the content campaign.

FIG. 7 depicts the changing use of models as the number of impressions increases and the objective funnel changes over time. Specifically, based on the number of impressions and the state of the objective funnel, models are strategically chosen to predict the occurrence of future conversions and determine a value for the content campaign. In some embodiments, based on the state of the objective funnel, a single model is used to predict the occurrence of conversions and determine a value of the campaign. In such embodiments, the chosen model may simply transition from one model to the next when a change in the state of the objective funnel occurs. In alternative embodiments, multiple models may be used to predict the occurrence of conversions, with each model assigned a weight to skew its influence in the prediction. This embodiment of weighted models is depicted in FIG. 7. To illustrate the selection and weighting of the models based on the state of the objective funnel, the three objective funnels of FIG. 7, the objective funnels 700A, 700B, and 700C, are analyzed in detail below.

The objective funnel 700A at time A is analyzed first. As seen in FIG. 7, 65% of the impressions 701 resulted in fulfillment of the click objective. In other words, 65% of the users presented with the content clicked on the content. 14% of the users presented with the content viewed the content for a specified period of time. 3% of the users added the product associated with the content to a shopping cart. Finally, 0% of the users presented with the content purchased the product associated with the content. Based on these results generated at time A, weights may be assigned to the models associated with these results.

A model's weight represents a confidence in that model and may be used to determine the extent to which that model is relied upon to predict the objective associated with the model, or another subsequent objective. Weights may be assigned based on a variety of factors. In some embodiments, a model's weight may be designated based on a sample size or a quantity of data that has been used to train the model. In alternative embodiments, a model's weight may be designated based on the proportion of users which fulfilled the objective associated with that model. In a further embodiment, a models weight may be designated based on the success that the model has in accurately predicting the occurrence of user fulfillment of the objective associated with the model. In further embodiments, the model's weight may be designated by the similarity of the objective associated with the model to the ultimate objective of the content campaign. Finally, the model's weight may not only be designated based on the performance of that model and fulfillment of the objective associated with the model, but it may also depend on the performance of additional models within the model funnel and fulfillment of the additional objectives within the objective funnel.

At time A, the weight of the click model 710 is set to 100%, and all other models have been assigned weights of 0%. In other words, the click model 710 exercises all power in determining a value for the content campaign. One reason for this weighting might be that the click model 710 is the only sufficiently trained model due to the small sample size of model training data that has been obtained at the early time A.

At time B, additional impressions 702 have occurred and the objective funnel is in the state of objective funnel 700B. In the objective funnel 700B, 70% of the impressions 702 resulted in fulfillment of the click objective. 37% of the users presented with the content viewed the content for a specified period of time. 11% of the users added the product associated with the content to a shopping cart. Finally, 5% of the users presented with the content purchased the product associated with the content. Based on these results generated at time B, weights are re-assigned to the models associated with these results. These weights are used to skew the amount of input that each model has in determining an updated value for the content campaign.

At time B, the weight of the click model 710 is set to 35%, the weight of the view model 720 is set to 40%, the weight of the add to cart model 730 is set to 25% and the weight of the purchase model 740 remains at 0%. As explained above, there are many different methods of assigning weights to models. For example, one reason for the increase in weights of the view model 720 and the add to cart model 730 may be because they surpassed a threshold sample size of training data required to instill confidence in their performance. On the other hand, one reason for the decrease in weight of the click model 710 might be because this model become less relevant as confidence and weighting for other models closer in similarity to the model associated with the ultimate purchase objective grew.

At time C, the greatest quantity of impressions 703 have occurred and the objective funnel is in the state of objective funnel 700C. In the objective funnel 700C, 70% of the impressions 703 resulted in fulfillment of the click objective. 55% of the users presented with the content viewed the content for a specified period of time. 41% of the users added the product associated with the content to a shopping cart. Finally, 22% of the users presented with the content purchased the product associated with the content. Based on these results generated at time C, weights are re-assigned to the models associated with these results.

At time C, the weight of the click model 710 is set to 10%, the weight of the view model 720 is set to 15%, the weight of the add to cart model 730 is set to 35% and the weight of the purchase model 740 has increased to 40%. Note that the weight of the click model 710 has again decreased. The weight associated with the view model 720 has also decreased relative to time B. As mentioned above with regard to the objective funnel 700B, one reason for these weight decreases may be because these models became less relevant as confidence grew in other models closer in similarity to the model associated with the ultimate purchase objective. For example, an increased weighting of the add to cart model 730 and the purchase model 740 may have resulted in a decrease in the importance of the less relevant models of the funnel.

These weights are used to skew the amount of input that each model has in determining an updated value for the content campaign. Because time C is the time point at which the greatest quantity of impression have occurred during the content campaign, the more relevant models (i.e. those closest in similarity to the ultimate content campaign objective) are to be the best trained at this point in time and thus possess the ability to determine the most accurate value yet.

Finally, note that updating the weights of the models used in determining a value can be performed at discrete, specified times as in FIG. 7, or continuously over time (not shown).

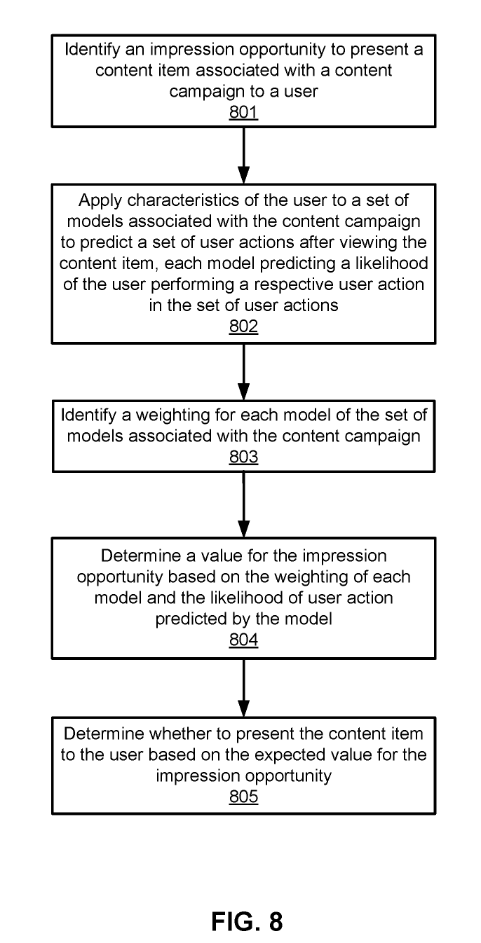

FIG. 8 is a flow chart of a method for using a set of models to determine a value of presenting content associated with a content campaign to a user of an online system, in accordance with an embodiment. In other embodiments, the method may include different and/or additional steps than those shown in FIG. 8. Additionally, steps of the method may be performed in different orders than the order described in conjunction with FIG. 8 in various embodiments.

As depicted in FIG. 8, the first step is to identify 801 an impression opportunity to present a content item associated with a content campaign to a user. In other words, a content slot located on an online system is identified as available for content presentation to a user viewing the online system. In one embodiment, the user may be deemed eligible for viewing the content item based on targeting criteria specified by the online system and fulfilled by the user.

The second step is to apply 802 characteristics of the user to a set of models associated with the content campaign to predict a set of user actions after viewing the content item, each model predicting a likelihood of the user performing a respective user action in the set of user actions. These characteristics may include but are not limited to demographic information or social information stored by the online system 104 or another third party system 103. For example, user characteristics may be obtained from the user profile store 201, the action log 204, or the edge store 205 of the online system 104. In alternative embodiments, user characteristics may be determined through the use of pixel tracking as described relative to FIG. 2. Some examples of user characteristics can be seen in FIG. 4 under the “user characteristics” heading.

In some embodiments, the set of models associated with the content campaign are the model funnels described with regard to FIG. 6 and the corresponding set of actions are the objectives associated with each model of the model funnel. In other words, step 802 includes applying user characteristics to models of a model funnel associated with the content campaign to determine the probability that the objectives associated with the models of the model funnel will be performed by that user. For example, the characteristics of a user might be applied to an add to cart model to determine the probability that the user will add the item associated with the content campaign to a shopping cart after being presented with the content item.

The next step is to identify 803 a weighting for each model of the set of models associated with the content campaign. In other words, step 803 weights each of the models of the model funnel in order to determine which models to rely upon in determination of a value for the impression opportunity. As described above, model weights may be assigned based on a variety of factors. In some embodiments, a model's weight may be designated based on a sample size or a quantity of data that has been used to train the model. In alternative embodiments, a models weight may be designated based on the success that the model has in accurately predicting the occurrence of user fulfillment of the objective associated with the model. In further embodiments, the model's weight may be designated by the similarity of the objective associated with the model to the ultimate objective of the content campaign. Weighting of the models of a model funnel is described in detail with regard to FIG. 7.

The subsequent step is to determine 804 a value for the impression opportunity based on the weighing of each model and the likelihood of user action predicted by the model. In other words, each model of the model funnel determines a value for the impression opportunity based on the determined probability that the user will perform the objective associated with the model. Then, the values determined by each model are weighted according to the weightings determined in step 803. These weighted values from each model are used to determine a final value for the impression opportunity. This enables more relevant, better trained models to have a greater input in the final value calculated.

The final step is to determine 805 whether to present the content item to the user based on the value for the impression opportunity. In the event that the content campaign's value is the highest value, the content item associated with the content campaign will be presented to the user. The user's response to the content item is then used to re-train the set of models to more effectively determine a value at the next impression opportunity. Thus the more users presented with the content item, the more trained the models become, and the more accurate the determined values become.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
identifying an impression opportunity to present a content item associated with a content campaign to a user;
applying characteristics of the user to a set of models associated with the content campaign to predict a set of user actions after viewing the content item, each model predicting a likelihood of the user performing a respective user action in the set of user actions;
identifying a weighting for each model of the set of models associated with the content campaign;
determining a value for the impression opportunity based on the weighing of each model and the likelihood of user action predicted by the model;
determining whether to present the content item to the user based on the value for the impression opportunity.

2. The method of claim 1, wherein identifying an impression opportunity comprises determining that the user satisfies targeting criteria specified by a third party system associated with the content campaign.

3. The method of claim 1, wherein each model of the set of models is associated with a user action.

4. The method of claim 3, wherein the user action is an objective of the content campaign.

5. The method of claim 3, wherein the models that comprise the set of models are ordered based on a predicted chronological ordering of user actions associated with each model of the set of models.

6. The method of claim 5, wherein the final model in the ordered set of models is associated with a user action desired by a third party system associated with the content campaign.

7. The method of claim 1, wherein identifying a weighting for each model of the set of models is based on a quantity of data that has been used to train the model.

8. The method of claim 1, wherein identifying a weighting for each model of the set of models is based on an accuracy of the model in predicting the fulfillment of a user action associated with the model.

9. The method of claim 1, wherein identifying a weighting for each model of the set of models is based on the similarity of the user action associated with the model to a user action desired by a third party system associated with the content campaign.

10. The method of claim 1, wherein identifying a weighting for each model of the set of models is based on weightings of the other models of the set of models.

11. A non-transitory computer-readable medium having instructions for execution by a processor causing the processor to:
identify an impression opportunity to present a content item associated with a content campaign to a user;
apply characteristics of the user to a set of models associated with the content campaign to predict a set of user actions after viewing the content item, each model predicting a likelihood of the user performing a respective user action in the set of user actions;
identify a weighting for each model of the set of models associated with the content campaign;
determine a value for the impression opportunity based on the weighing of each model and the likelihood of user action predicted by the model;
determine whether to present the content item to the user based on the value for the impression opportunity.

12. The non-transitory computer-readable medium of claim 11, wherein identifying an impression opportunity comprises determining that the user satisfies targeting criteria specified by a third party system associated with the content campaign.

13. The non-transitory computer-readable medium of claim 11, wherein each model of the set of models is associated with a user action.

14. The non-transitory computer-readable medium of claim 13, wherein the user action is an objective of the content campaign.

15. The non-transitory computer-readable medium of claim 13, wherein the models that comprise the set of models are ordered based on a predicted chronological ordering of user actions associated with each model of the set of models.

16. The non-transitory computer-readable medium of claim 15, wherein the final model in the ordered set of models is associated with a user action desired by a third party system associated with the content campaign.

17. The non-transitory computer-readable medium of claim 11, wherein identifying a weighting for each model of the set of models is based on a quantity of data that has been used to train the model.

18. The non-transitory computer-readable medium of claim 11, wherein identifying a weighting for each model of the set of models is based on an accuracy of the model in predicting the fulfillment of a user action associated with the model.

19. The non-transitory computer-readable medium of claim 11, wherein identifying a weighting for each model of the set of models is based on the similarity of the user action associated with the model to a user action desired by a third party system associated with the content campaign.

20. The non-transitory computer-readable medium of claim 11, wherein identifying a weighting for each model of the set of models is based on weightings of the other models of the set of models.
